(19) United States
(12) Patent Application Publication
(10) Pub. No.: US 2012/0191477 A1
(43) Pub. Date: Jul. 26, 2012

(54) Delivery of Information to Patients

(75) Inventors: Andrew J. Kugler, Albany, NY (US); Brian J. Buys, Fairport, NY (US); Corinn C. Fahrenkrug, Chittenango, NY (US); Christopher M. Keegan, Marcellus, NY (US); Marshall W. Magee, Skaneateles, NY (US); Eric P. Jensen, Niskayuna, NY (US)

(73) Assignee: WELCH ALLYN, INC., Skaneateles Falls, NY (US)

(21) Appl. No.: 13/358,260

(22) Filed: Jan. 25, 2012

Related U.S. Application Data
(60) Provisional application No. 61/436,245, filed on Jan. 26, 2011.

(51) Int. Cl. G06Q 50/24; G06Q 50/20; G09B 23/28; G06Q 40/00

(52) U.S. Cl. 705/3; 705/39; 434/262

(57) ABSTRACT

A method for educating a patient in a location at which care will be given includes: positioning the patient in the location at which the patient will be examined by a caregiver; identifying one or more modules of educational information relevant to the patient; accessing the modules at a computing device located in the location; and presenting the modules to the patient.

### RELATED APPLICATION

This application claims the benefit of U.S. Patent Application Ser. No. 61/436,245 on Jan. 26, 2011, the entirety of which is hereby incorporated by reference.

### BACKGROUND

Patients can spend large amounts of time waiting in rooms where care is provided by healthcare providers. This idle time can cause anxiety for a patient and can be viewed as a lost opportunity for both the patient and a caregiver. The patient can view the idle time as lost time that could be used for other purposes. Similarly, the caregiver can view the idle time as a lost opportunity to increase patient trust and education.

### SUMMARY

In one aspect, a method for educating a patient in an examination room includes: positioning the patient in the examination room, the examination room being a location at which the patient will be examined by a caregiver; identifying one or more modules of educational information relevant to the patient; receiving the modules at a computing device located in the examination room; and presenting the modules to the patient.

In another aspect, a method for educating a patient in a location at which care will be given includes: allowing a third party to sponsor educational information; loading the educational information from the third party; positioning the patient in the location at which the patient will be examined by a caregiver; allowing the caregiver or the patient to select one or more modules of the educational information relevant to the patient; receiving the modules at a computing device located in the location; presenting the modules to the patient; receiving input from the patient related to one of the modules; and reporting viewing information to the third party.

In yet another aspect, a wall or desk unit in a location at which care will be given includes: a plurality of medical instruments; and a device configured to show educational information to a patient in the location, the device including: a display; a processor; and memory encoding instructions that, when executed by the processor, cause the device to: allow a caregiver or the patient to select one or more modules of the educational information relevant to the patient; access the modules; present the modules to the patient on the display; receive input from the patient related to one of the modules; and report viewing information.

DESCRIPTION OF THE FIGURES

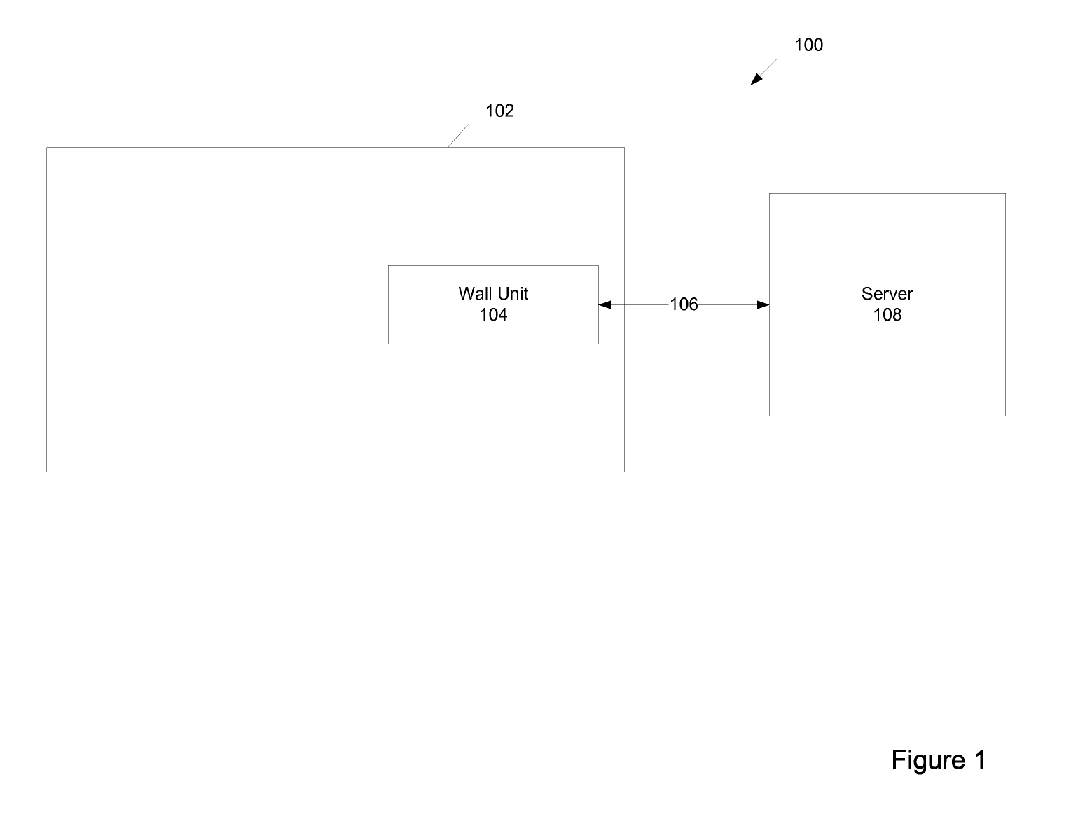

FIG. 1 shows an example location at which a patient is examined.

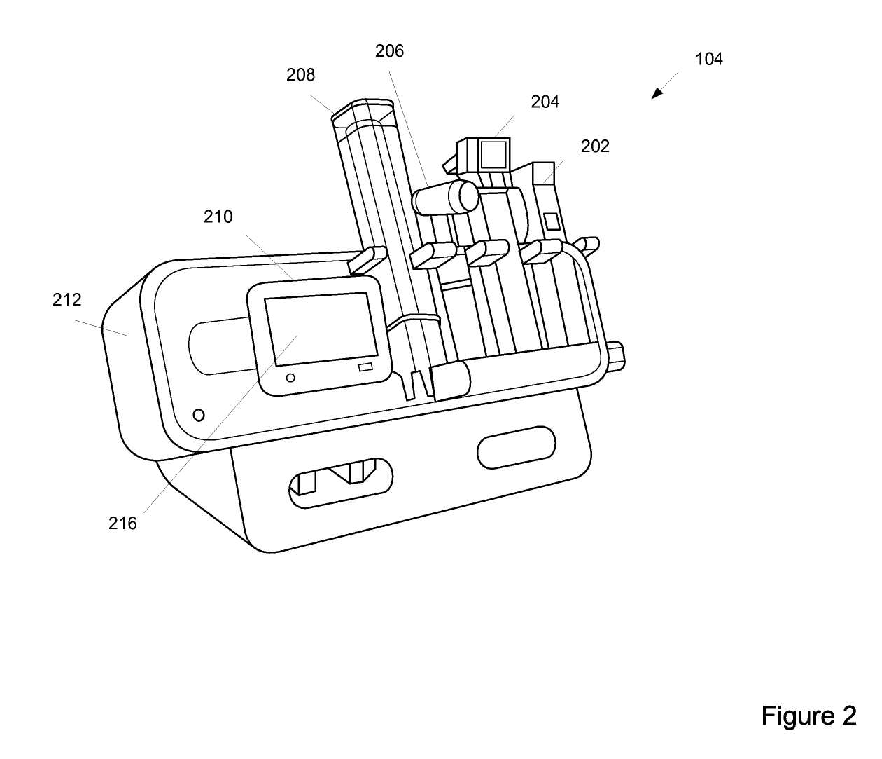

FIG. 2 shows an example wall unit from an examination room at the location of FIG. 1.

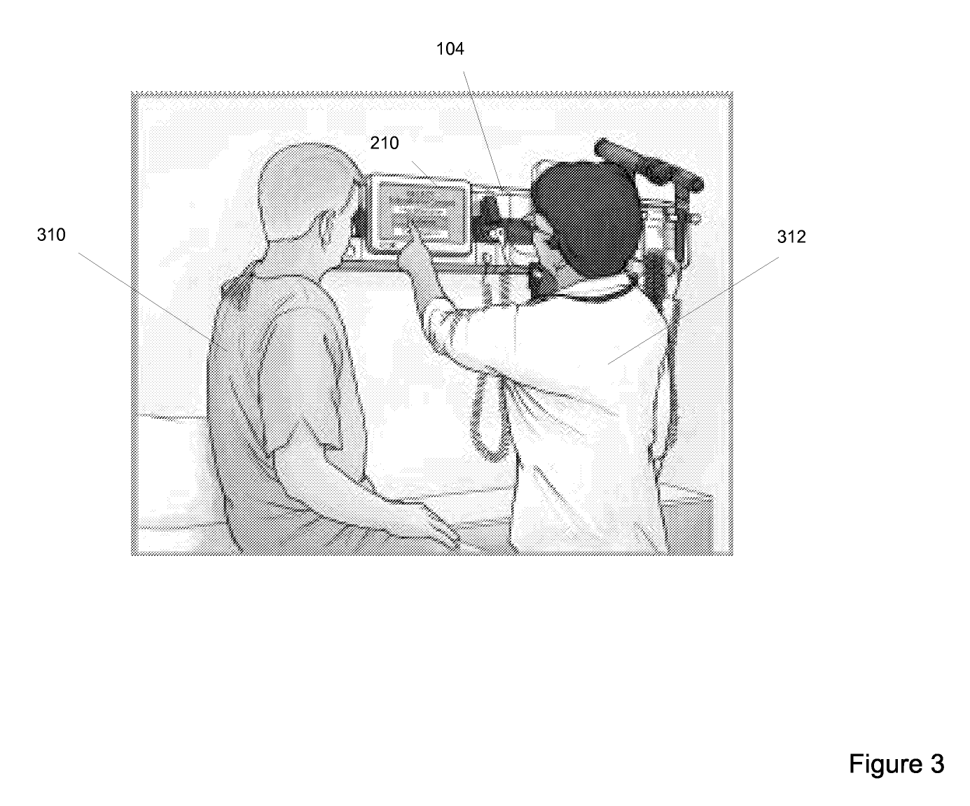

FIG. 3 shows a caregiver and a patient interacting with a device on the wall unit of FIG. 2.

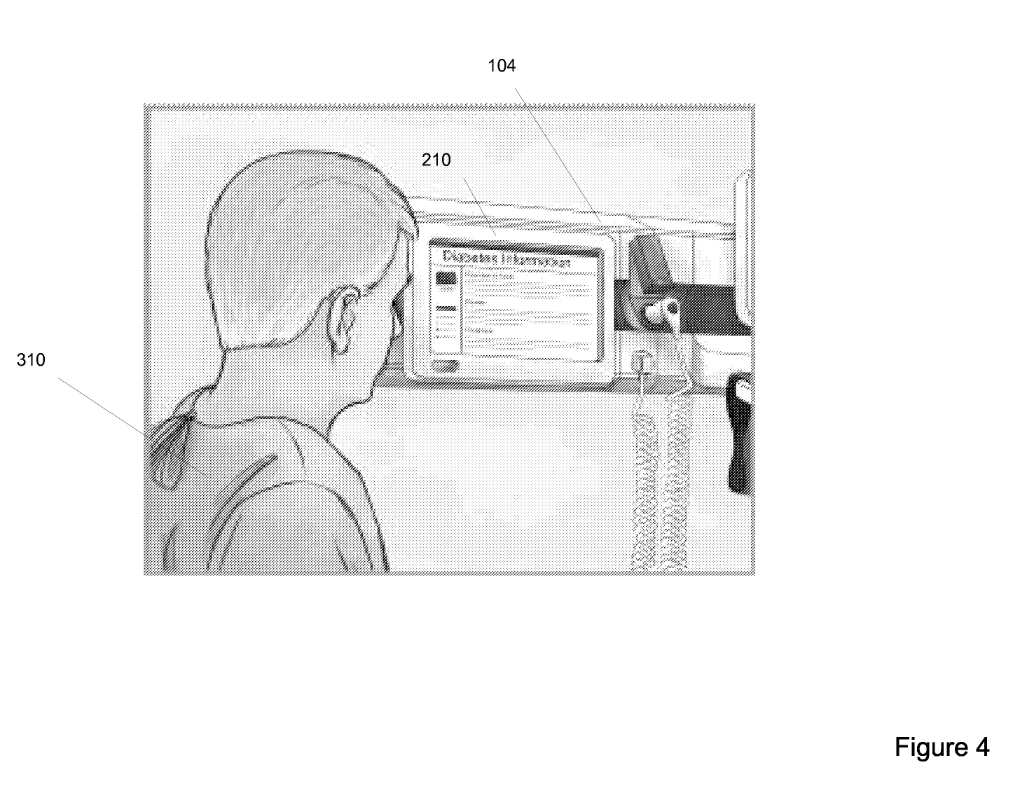

FIG. 4 shows the patient viewing educational information on the device of FIG. 3.

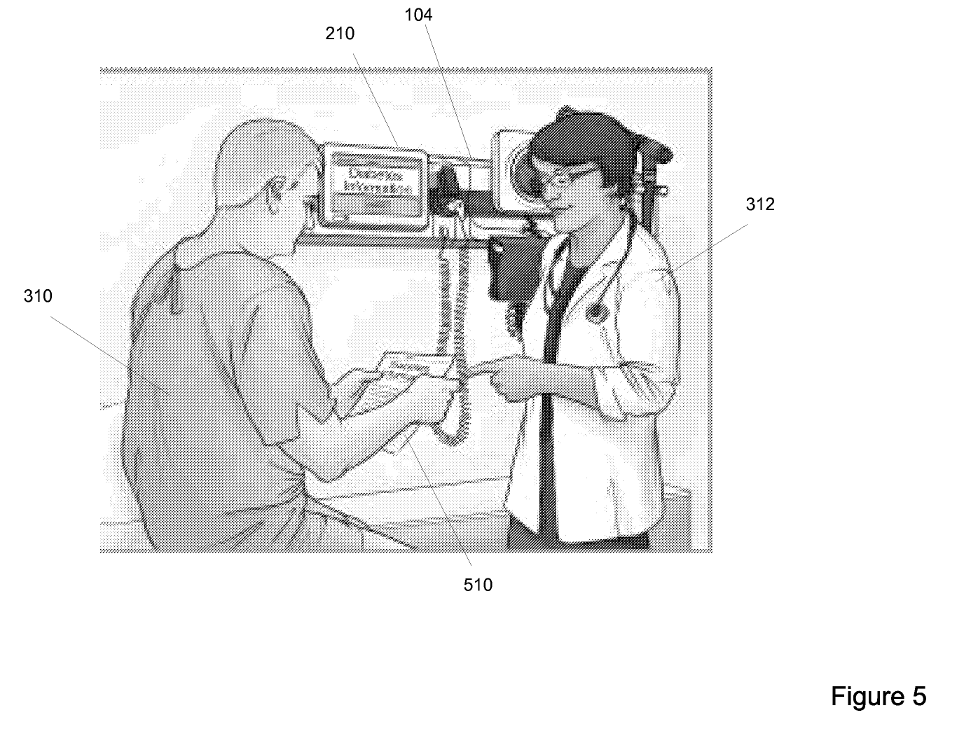

FIG. 5 shows the patient receiving hard copy information.

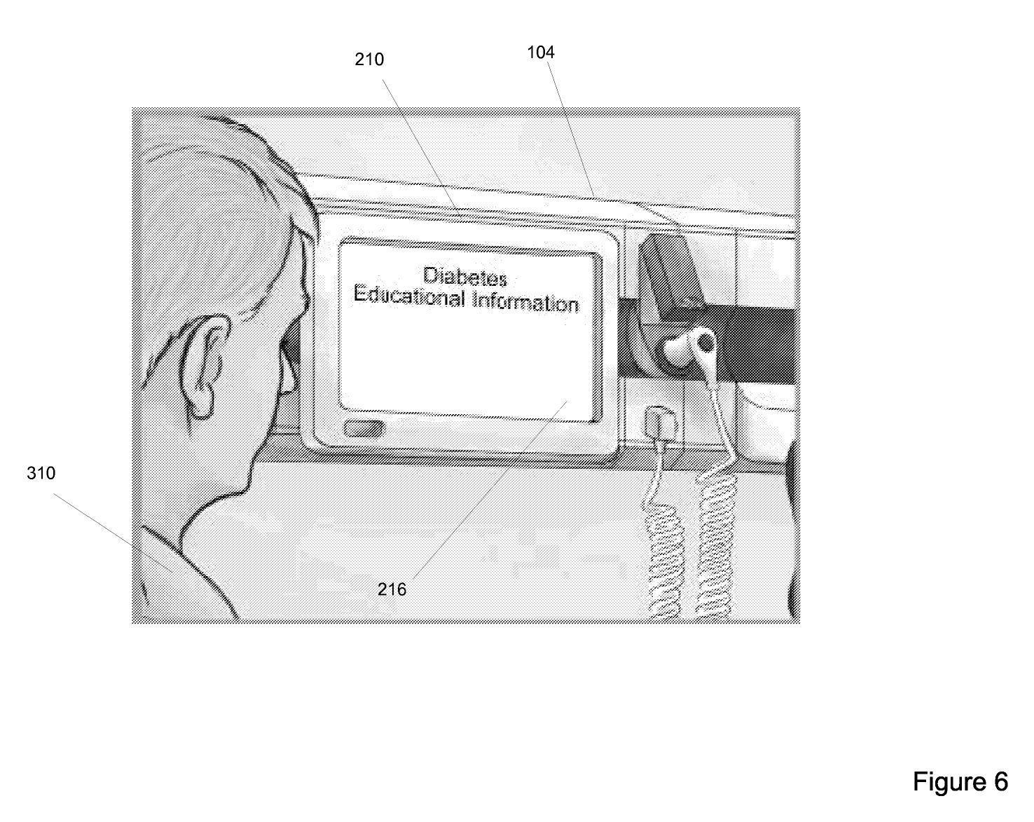

FIG. 6 shows the patient viewing sponsorship information on the device of FIG. 3.

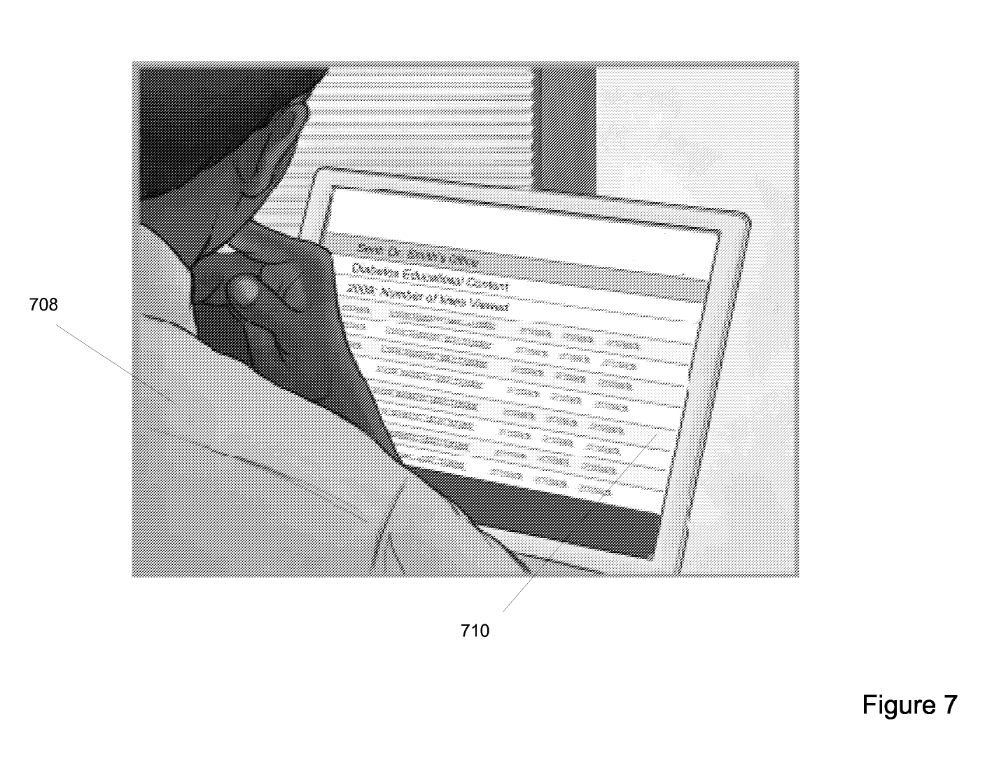

FIG. 7 shows a representative of a third party entity reviewing a viewing report.

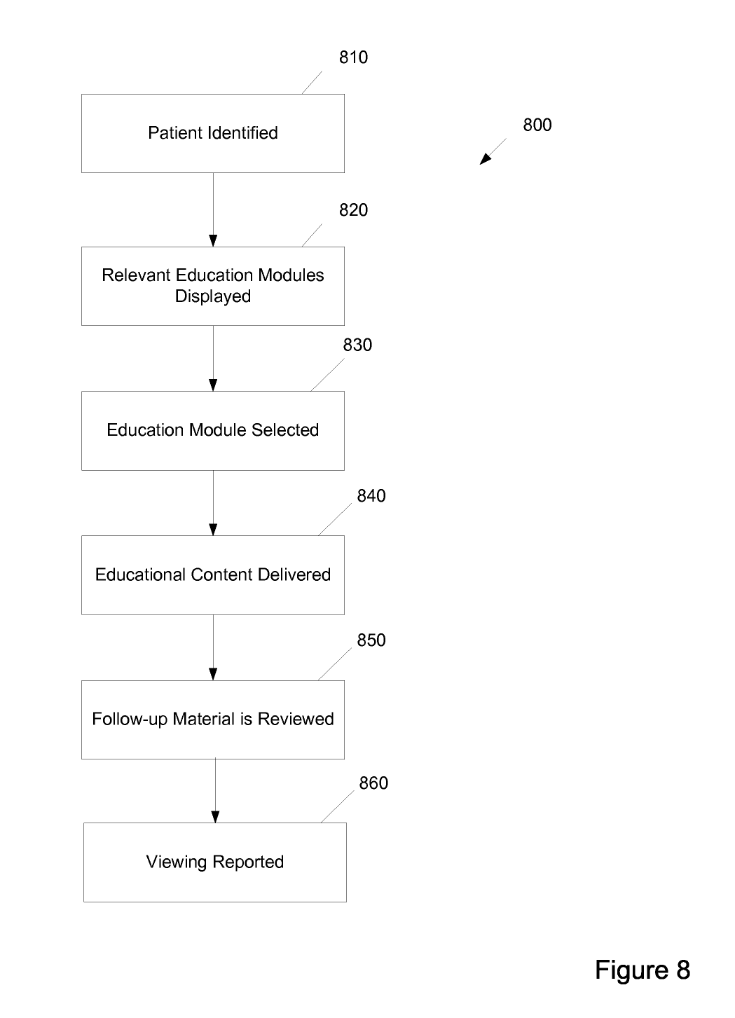

FIG. 8 shows an example method for viewing educational information.

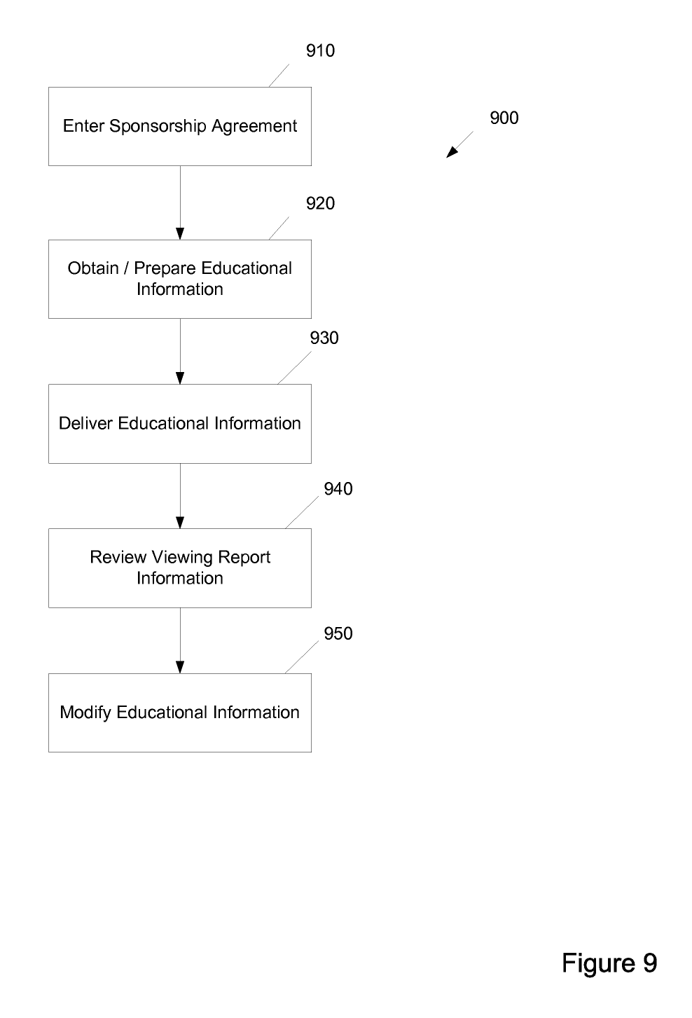

FIG. 9 shows an example method for providing educational information.

### DETAILED DESCRIPTION

The present disclosure relates to patient education at a point of care. In some examples described herein, the patient is presented with educational information before, during, and/or after an examination. The educational information can be tailored to provide the patient with relevant information related to the patient's current health status.

One embodiment includes a display that is located in a patient examination room. Content is delivered to the display that is relevant to the patient's health status. Example content includes presentations that describe treatment options and interactive questionnaires that gather further information from the patient and/or allow the patient to select the content that is delivered.

Clinical and economic benefits are realized when the patient more fully understands the patient's conditions and collaborates with the caregiver on treatment. Allowing the caregiver to direct the patient to vetted, credible educational content during idle time in the examination room can result in a decrease patient boredom, an increase in collaboration, and ultimately improve outcomes.

Referring now to FIG. 1, an example location 100 for providing care to patients is shown, such as a doctor's office or hospital. In this example, the location 100 includes an examination room 102 and a server 108.

Although only a single examination room and server are shown, multiple examination rooms can be provided. In addition, more servers can be used. The depicted configuration is only one example.

The examination room 102 is a location in which care is provided to a patient. The examination room 102 typically includes medical instruments and furniture, such as chairs and benches that allow the patient to be examined. In other examples, the room 102 can be in other venues, such as a physician's office, including a desk, etc. Other locations are possible.

The examination room 102 also includes a diagnostic wall unit 104. As shown in FIG. 2, the diagnostic wall unit 104 includes a base 212 that can be mounted to a wall of the examination room 102 or otherwise be positioned within the examination room 102. The base 212 houses several instruments that are used during the examination of the patient. These instruments can include, for example, an otoscope 202, an ophthalmoscope 204, a digital blood pressure instrument 206, and/or a body temperature instrument 208.

The wall unit 130 also includes a device 210 configured to provide information to the patient and caregiver. In this example, the device 210 includes a display 216 configured to present data to the caregiver (e.g., patient information such as electronic health records) and the patient (e.g., educational information, as described further below).

In one example, the device 210 is a computing device. A computing device is a physical, tangible device that processes data. Example types of computing devices include personal computers, standalone server computers, blade server computers, mainframe computers, handheld computers such as tablets and slates, smart phones, special purpose computing devices, and other types of devices that process data.

The device 210 can include at least one central processing unit (“CPU” or “processor”) and a system memory. The CPU executes software instructions stored on the system memory.

The system memory is one or more physical devices that can include a random access memory (“RAM”) and a read-only memory (“ROM”). A basic input/output system containing the basic routines that help to transfer information between elements within the device 210, such as during startup, is stored in the ROM. The system memory can also include a mass storage device.

The mass storage device and its associated computer-readable data storage media provide non-volatile, non-transitory storage. Although the description of computer-readable data storage media contained herein refers to a mass storage device, such as a hard disk or CD-ROM drive, it should be appreciated by those skilled in the art that computer-readable data storage media can be any available non-transitory, physical device or article of manufacture from which the device 210 can read data and/or instructions.

The system memory of the device 210 can store software instructions and data. The software instructions include an operating system suitable for controlling the operation of the device 210. The system memory also stores software instructions, that when executed by the CPU, cause the device 210 to provide the functionality discussed herein.

Referring again to FIG. 1, the device 210 of the diagnostic wall unit 104 communicates with the server 108 to provide information to the caregiver and/or patient located in the examination room 102. In this example, the device 210 can operate in a networked environment using logical connections, such as a connection 106, to the server 108. The connection 106 can be a local network, the Internet, or another type of network. As describe below, the connection 106 can be wired and/or wireless.

The device 210 communicates with the server 108 using known techniques, such as hardwired, Bluetooth and/or Wi-Fi. One or more protocols can be used to facilitate the communications.

In some examples, the device 210 communicates using a protocol such as the Welch Allyn Communications Protocol (WACP). WACP uses a taxonomy as a mechanism to define information and messaging. Taxonomy can be defined as description, identification, and classification of a semantic model. Taxonomy as applied to a classification scheme may be extensible. Semantic class-based modeling utilizing taxonomy can minimize the complexity of data description management by limiting, categorizing, and logically grouping information management and operational functions into families that contain both static and dynamic elements.

In this example, the display 216 of the device 210 is a touch screen that allows the patient and/or caregiver to interact with the device 210. The device 210 is configured to display information, such as educational information. The educational information can be tailored to the specific health status of the patient so that relevant information is provided.

The server 108 is also a computing device that houses data relevant to the patient and caregiver. For example, the server 108 can include one or more databases housing medical data, such as electronic health records. The server 108 can also store educational information, such as presentations, about different health status of patients. The data can be requested from the server 108 by the device 210, and the server 108 delivers the requested data to the device 210. For example, the device 210 can request specific educational content, and the server 108 can deliver that content to the device 210 for presentation to the patient.

Referring now to FIGS. 3-6, one example use of the device 210 is shown.

In FIG. 3, a caregiver 312 is shown interacting with the device 210. The caregiver 312, along with possible input from the patient 310, selects content on the display 216 of the device 210.

This content can be selected based on a condition of the patient 310, such as a health status like diabetes or congestive heart failure. Multiple menus can be provided based on categories that allow the user to select the desired content. In one example, content specific to the condition(s) of the patient 310 are automatically suggested based on information pulled from an electronic health record associated with the patient.

In other examples, the patient 310 can also select the content. For example, once the patient 310 is brought to the examination room 102, the patient 310 can review categories of educational information provided on the display 216 of the device 210 before the caregiver 312 enters to conduct the examination. In one example, the patient 310 is presented with categories of information related to a particular health status that is relevant to the patient 310, such as diabetes treatment. The patient 310 can select the desired content to review.

Another example involves collaboration between the caregiver 312 and the patient 310. The caregiver 312 guides the patient 310, highlighting possible content areas of interest based on currently medical conditions.

In FIG. 4, the selected content is delivered to the device 210. In some examples, the content is a presentation of educational information about the selected topic. In other examples, the content can be interactive, requiring input from the patient 310. The caregiver 312 need not be present when the content is delivered. In some examples, the content is delivered while the caregiver 312 is outside the location, allowing the patient 310 to be educated while allowing the caregiver 312 to attend to other activities.

In some examples, the educational information is related to a health status of the patient. Examples of such health statuses include diabetes, congestive heart failure, and obesity, to name a few.

For example, the content can include a video about administering insulin as part of a treatment plan for diabetes. Upon conclusion of the presentation, an interactive quiz could be provided to the patient 310. The selections are made through the touchscreen on the display 216. The responses provided by the patient 310 can be used for various purposes, such as gauging patient understanding of the content or topic, assisting in the selection of additional educational information, and/or obtaining feedback about the efficacy of the content.

Referring now to FIG. 5, the patient 310 could be provided with hard copy information 510. The hard copy information 510 can be information related to the content provided on the device 210.

For example, the hard copy information 510 can be a set of instructions for administering insulin as part of the treatment plan for diabetes. The hard copy information 510 can be taken by the patient 310 as a reminder of the information provided.

In other examples, the hard copy information 510 can be other information, such as sources of additional educational content, or referral information for further caregiving. In another example, additional educational information can be delivered by other methods, such as electronically (e.g., if the patient provides an email address) or by regular mail. Other configurations are possible.

Referring now to FIG. 6, information about the origin or sponsorship for the educational information is provided on the display 216 of the device 210. Such information can, for example, be in the form of an advertisement or indication of sponsorship or affiliation.

For example, as provided in more detail below, the content for the educational information can be created and/or sponsored by one or more entities (e.g., large healthcare organizations, medical device manufacturers, and/or pharmaceutical firms). Those entities can, in some circumstances, provide advertisements that are viewed by the patient 310 before, during, and/or after reviewing the educational information on the device 210.

Referring now to FIG. 7, in some examples, the entities that create and/or sponsor the educational information are provided with a report 710 that provides viewing information. For example, a representative 708 associated with a third party entity that sponsored educational content is reviewing the report 710, which lists how many times particular educational information was shown in a location, such as a doctor's office or hospital.

Referring now to FIG. 8, an example method 800 for viewing the educational information is shown.

At operation 810, the patient is identified in the computing device. This can include providing unique information to identify the particular patient, or simply providing information about the patient, such as a disease state.

Next, at operation 820, relevant educational information is displayed. In this example, the information is displayed in modules. The modules can be generated based on the identification of the patient. For example, if the patient is uniquely identified, the computing device can query an electronic health record associated with the patient to determine what educational information would be relevant to the patient. In another example, if the disease status for the patient is provided, the modules can be selected based on the disease status.

In this manner, the educational information is personalized based on the patient's active diagnoses or medical history, making the information more informative and powerful. The patient can actively agree to view material in a location (e.g., the examination room) in private, allowing the patient to view content that might be embarrassing in public.

In one example, the patient can be invited to use the display by the caregiver, or the display can have a message asking the patient to interact with the device if the patient wishes to obtain information. In this manner, the patient controls what information is provided.

Next, at operation 830, the desired module(s) are selected by the patient and/or the caregiver. In one example, the patient can make the selections while waiting in the examination room for an examination. In another example, the caregiver (e.g., a nurse) selects the modules before or after an examination.

Next, at operation 840, the selected educational information is delivered. The information can include one or both of presentations and interactive programs. This allows the patient to utilize time that may otherwise be wasted, such as the time spent waiting for examination. It also educates the patient, allowing the patient to be better prepared for the examination and to ask more educated questions and participate more fully in the patient's care.

As previously noted, the content can be downloaded from the server as needed, or the content can be stored on the device through pre-installation or loaded by USB or network connectivity.

Generally, interactive educational information viewed before the examination can make the patient/caregiver interaction more efficient and more effective. Content can also be referred to during the examination. The use of interactive programs can also be used to keep patient attention, gauge patient understanding, and obtain feedback to optimize the content.

The educational information can be delivered in modules or chunks of a given size, such as 2-5 minute blocks. If additional time is available, the patient can watch multiple modules.

At operation 850, any follow-on information is provided to the patient. For example, the patient can be provided with hard copy information to take with the patient to remind the patient of the viewed educational information, as well as provide the patient with opportunities to obtain additional content.

Finally, at operation 860, the viewing of the educational information is reported. For example, the computing device can send a confirmation message to the server indicating that certain educational information has been viewed. The server can maintain a report listing the number of viewers for each module of educational information. The report can also provide other information, such as disease states for the viewers, medication and rehabilitation prescribed for the viewers, etc. Such information is maintained in an anonymous fashion to preserve patient privacy.

Referring now to FIG. 9, an example method 900 for providing the educational information is shown.

Initially, at operation 910, a third party entity enters into a sponsorship agreement to deliver the educational information. The sponsorship agreement could be administered by the manufacturer and/or distributor of the wall unit 104. In other examples, the agreement could be administered by the location.

The sponsorship agreement could include both payment for sponsorship rights and/or an agreement to provide relevant educational information. The payment could be based, in part, on the number of views for the educational information. For example, the sponsorship cost could be based, at least in part, on the number of times particular educational information is viewed by patients. In some examples, the sponsorship could also include subsidizing part of the cost of the hardware to deliver the educational information to the patient.

For example, in one embodiment, the entity is a pharmaceutical company that makes insulin to treat diabetes. The pharmaceutical company enters into an agreement with a healthcare system to deliver educational information to the system for viewing by the system's patients. For example, the educational information can include information on how to identify and treat diabetes.

By entering into sponsorship agreements, the systems, such as outpatient care facilities and hospitals, can provide additional educational information to the systems' patients with little or no additional cost to the systems. For example, since the content can be delivered using hardware (i.e., the computing device) that already exists in each examination room, a system does not have to purchase and find space for additional hardware and a display in the examination room.

In another example, the system can use sponsorship money to pay for a portion or all of the costs associated with installing the wall units in examination rooms.

The pharmaceutical company can also benefit in several ways. For example, the pharmaceutical company may be allowed to get exposure by having a brief screen at the end of the content indicating who sponsored the content, or deliver advertising information, which allows the patient to become more aware of the drug options for the patient. The pharmaceutical company also can receive reports on the number of views, etc., as described further herein.

Referring again to FIG. 9, at operation 920, the entity obtains and/or prepares educational information. For example, the entity may purchase educational information from one or more sources of such content. In another example, the entity can create the educational information.

Next, at operation 930, the entity delivers the educational information to the location. This can be done in hard copy and/or electronic forms.

Next, at operation 940, the entity is allowed to review reports detailing the use of the educational information. This can include information on the number of views for each module. It can also include anonymous information about each viewer, such as disease state and whether or not the caregiver prescribed any drugs or other therapy treatments. The information can also include information collected from the patients, such as survey information on how effective and/or relevant the patients felt the information was. Other feedback could also be provided.

Finally, at operation 950, the entity may choose to modify the educational content based on the reports provided to the entity. For example, if certain modules are indicated by patients to be ineffective, the entity can rework these modules to better optimize the content.

In another example embodiment, educational and/or sponsorships information can be provided at various times during examination as well. For example, if a patient's blood pressure is taken and the results are high, the device can be programmed to automatically provide educational information and/or treatment options for hypertension to the patient. For example, upon a high reading, the device can be programmed to automatically display information about drugs from one or more sponsors that can be used to treat the hypertension.

In such an embodiment, the device can be programmed to interact with the instruments on the wall unit, as well as possibly with other instruments included in the examination room. Upon a diagnostic test being performed, the device can analyze the results and send an appropriate query to the server for any educational information or sponsorship information relevant to the results of the test. The server can respond to the query by delivering the relevant educational information and/or sponsorship information to the device for display to the patient. This query can be performed in an anonymous manner to protect patient privacy.

In another example, the device can present more than educational information. In this embodiment, the device is used to present data to the patient, such as trending of the data associated with the patient. This information allows the patient and caregiver to better track a patient's progress when addressing specific health statuses, such as disease states.

One example of such a health status is when a patient is hypertensive. The device can pull data from the patient's electronic health record on the server to provide a trend of blood pressure over time. This helps the patient understand whether or not the patient's clinical situation is improving and motivates the patient to stay with the program of medication and/or healthy living.

In another example, a patient may exhibit chronic obstructive pulmonary disease. The device can be programmed to show the patient spirometry trending information across multiple visits to see if the forced volume vital capacity (FVC) values are improving with medication.

In yet another example, the health status could indicate obesity. In this example, the device can access data to show weight, body mass index (BMI), cholesterol, etc. trends to encourage the patient to stay on the program, increase the program, and know where the patient stands with respect to the patient's goals.

In such examples, the patient can interact with the device to show different data or show data in different contexts. For example, the patient can request BMI trends over a specified range (e.g., 6 months, 1 year, 5 years), and the device can pull the requested data and show the trends. In such examples, the device could communicate with the server using the WACP or other protocols.

In another alternative, the device including the display need not be part of the wall unit. The device can be a separate device that is located on a wall or other structure within the examination room. In another example, the device is portable, so that the patient and/or caregiver can hold and move the device around the room when in use. Such a device can communicate wirelessly with the server. Other configurations are possible.

The various embodiments described above are provided by way of illustration only and should not be construed as limiting. Those skilled in the art will readily recognize various modifications and changes that may be made without following the example embodiments and applications illustrated and described herein, and without departing from the true spirit and scope of the disclosure.

What is claimed is:

1. A method for educating a patient in a location at which care will be given, the method comprising:
positioning the patient in the location at which the patient will be examined by a caregiver;
identifying one or more modules of educational information relevant to the patient;
accessing the modules at a computing device located in the location; and
presenting the modules to the patient.

2. The method of claim 1, wherein presenting the modules further comprises presenting the modules prior to an examination of the patient in the location.

3. The method of claim 1, wherein identifying the modules further comprises allowing the caregiver or the patient to select the modules.

4. The method of claim 1, wherein identifying the modules further comprises:
querying an electronic health record of the patient; and
automatically selecting the modules based on the electronic health record.

5. The method of claim 1, further comprising using the computing device currently provided in the location, the computing device being incorporated as part of a wall or desk unit.

6. The method of claim 1, further comprising receiving input from the patient.

7. The method of claim 6, further comprising presenting one or more questions related to the modules to the patient.

8. The method of claim 1, further comprising allowing a third party to sponsor the educational information.

9. The method of claim 8, further comprising receiving the educational information from the third party.

10. The method of claim 9, further comprising reporting viewing information to the third party.

11. The method of claim 10, further comprising receiving payment from the third party based on the viewing information.

12. The method of claim 1, further comprising:
requesting data associated with at least one health status of the patient; and
showing a representation of the data associated with the health status.

13. The method of claim 12, wherein showing the representation further comprises showing a trend of the data associated with the health status.

14. A method for educating a patient in a location at which care will be given, the method comprising:
allowing a third party to sponsor educational information;
loading the educational information from the third party;
positioning the patient in the location at which the patient will be examined by a caregiver;
allowing the caregiver or the patient to select one or more modules of the educational information relevant to the patient;
receiving the modules at a computing device located in the location;
presenting the modules to the patient;
receiving input from the patient related to one of the modules; and
reporting viewing information to the third party.

15. The method of claim 14, wherein presenting the modules further comprises presenting the modules prior to an examination of the patient in the location.

16. The method of claim 14, further comprising presenting one or more questions related to the modules to the patient.

17. The method of claim 14, further comprising using the computing device currently provided in the location, the computing device being incorporated as part of a wall or desk unit.

18. The method of claim 14, further comprising:
requesting data associated with at least one health status of the patient; and
showing a representation of the data associated with the health status.

19. The method of claim 18, wherein showing the representation further comprises showing a trend of the data associated with the health status.

20. A wall or desk unit in a location at which care will be given, comprising:
a plurality of medical instruments; and
a device configured to show educational information to a patient in the location, the device including:
a display;
a processor; and
memory encoding instructions that, when executed by the processor, cause the device to:
allow a caregiver or the patient to select one or more modules of the educational information relevant to the patient;
access the modules;
present the modules to the patient on the display;
receive input from the patient related to one of the modules; and
report viewing information.
